(19) United States
(12) Patent Application Publication
(10) Pub. No.: US 2003/0190428 A1
(43) Pub. Date: Oct. 9, 2003

(54) Method and apparatus for reducing fluid flow disruptions

(75) Inventor: Rajendra D. Deshpande, Nekoosa, WI (US)

Correspondence Address: GREER, BURNS & CRAIN, LTD., Suite 2500, 300 South Wacker Drive, Chicago, IL, 60606, US

(73) Assignee: Stora Enso North America Corporation

(21) Appl. No.: 10/115,536

(22) Filed: Apr. 3, 2002

(51) Int. Cl. B05D 3/12

(52) U.S. Cl. 427/356; 239/102.1; 239/4

(57) ABSTRACT

A method, apparatus, system, and computer program product for clearing flow disruptions in the coating applicator comprises vibrating at least a portion of the applicator to clear flow disruptions. In an apparatus embodiment of the invention, at least one vibrator is attached to a nozzle portion of the applicator for generating vibrations having a frequency of less than about 20 kHz and an intensity of at least 3 G, and a magnitude of less than 10% of a minimum nozzle slot width. A system embodiment comprises a web inspection system down stream of the applicator to detect coating defects and communicate a cross-machine location of the defect to activate vibrations at that location to clear the flow disruption.

### FIELD OF THE INVENTION

The present invention is related to methods, apparatuses, systems, and computer program products for clearing or reducing fluid flow disruptions in the application of coatings to substrates such as paper.

### BACKGROUND OF THE INVENTION

Coating a web of paper is generally effected by the application of a liquid coating material onto a moving web. The coating material may be comprised of a solid constituent suspended in a liquid carrier. The quality of the coating applied onto the paper web depends upon a number of factors, an important one of which being how the material is applied. The application of the coating material should preferably result in a coating that is smooth, continuous and uniform across the web.

Fountain coating of paper is a coating process in which the liquid coating material is jetted in a free-standing curtain of coating liquid directly onto the moving web with a fountain applicator. The fountain applicator comprises an elongate nozzle that includes a metering slot for communicating the coating fluid onto the web. The nozzle extends in a cross-machine direction coextensive with the paper web moving adjacent to it and supported by a backing roll. A downstream doctor blade meters and smoothes the coating. The amount of coating applied to the web may be controlled by controlling the size of the metering slot and pressure of the coating fluid. Desirably, a substantially uniform coating layer is applied across the width of the web. Fountain coating applicators are generally known in the art, with examples disclosed in U.S. Pat. Nos. 5,436,030 to Damrau and commonly owned by the assignee of the present application, which is hereby incorporated by reference.

Despite many years of practice, unresolved problems remain associated with paper coating. For example, impurities such as fiber bundles, dried coating, coating clumps, foreign matter, and the like, occasionally clog the nozzle metering slot and disrupt coating flow. Coating defects in the form of streaks or other inconsistencies can result. Paper production with streaks or other defects, cannot be sold. Further, if a clog is not removed quickly, the coater blade may not receive adequate lubrication and become damaged. Blade replacement requires costly machine downtime, with resultant production losses.

### SUMMARY OF THE INVENTION

The present invention is directed to apparatus, method, system, and computer program product embodiments for reducing and clearing clogs and other flow disruptions in coating applicators. A method embodiment of the invention generally comprises the steps of vibrating at least a portion of the nozzle at the natural frequency of the nozzle. The vibrations have a frequency less than about 20 kHz, an intensity that is at least about 3G, and a magnitude of less than about 10% of the minimum gap width of the nozzle metering slot. An apparatus embodiment of the invention comprises a fountain coater having a vibrator attached thereto for vibrating at least a portion of the fountain coater at a frequency of less than about 20 kHz, an intensity of at least about 3G, and at a magnitude of less than about 10% of the minimum gap width of the metering slot. A system embodiment of the invention comprises combining an apparatus embodiment with a downstream inspection means for detecting coating defects and communicating a signal to the vibrator after detecting the defect. Preferably magnetorestrictive vibrators are used to produce the desired vibrations.

Embodiments of the present invention solve otherwise unresolved problems in the art. It has been discovered that vibrations of relatively high frequency (but less than ultrasonic), high intensity, and low magnitude are effective to clear clogs and other fluid flow disruptions. Taking advantage of the natural frequency of a nozzle portion and/or use of the preferred magnetorestrictive vibrators results in favorably high energy vibrations with relatively low energy input.

The above brief description sets forth broadly some of the features and advantages of the present disclosure so that the detailed description that follows may be better understood, and so that the present contributions to the art may be better appreciated. Before explaining example embodiments of the disclosure in detail, it is to be understood that the disclosure is not limited in its application to the details of the specific embodiments set forth in the following description or illustrated in the drawings. The invention may take the form of modified and further embodiments, as will become apparent from this disclosure. Also, it is to be understood that the terminology employed herein is for description and not limitation.

### BRIEF DESCRIPTION OF THE DRAWINGS

FIG. 1 is a schematic elevational view of a coater station illustrating an embodiment of the invention.

FIG. 2 is a cross-sectional view of a fountain applicator having a vibrator mounted to the nozzle thereof.

FIG. 3 is a schematic perspective view of a coater system embodiment of the invention.

FIG. 4 is a flow chart illustrating a computer program embodiment of the invention.

### DETAILED DESCRIPTION

Before discussing several embodiments of the invention in detail, it will be appreciated that the discussion herein and the drawings may be useful in describing any of method, apparatus, system, and/or computer program product embodiments of the invention. Accordingly, it will be understood that discussion herein related to any of the embodiments of the invention may relate to another embodiment. By way of example, it will be appreciated that a computer program product embodiment may comprise computer readable instructions stored in a computer readable medium that when executed by a computer cause the computer to carry out the steps of a method embodiment. Similarly, it will be appreciated that a method embodiment of the invention may comprise performing steps using a system or an apparatus of the invention.

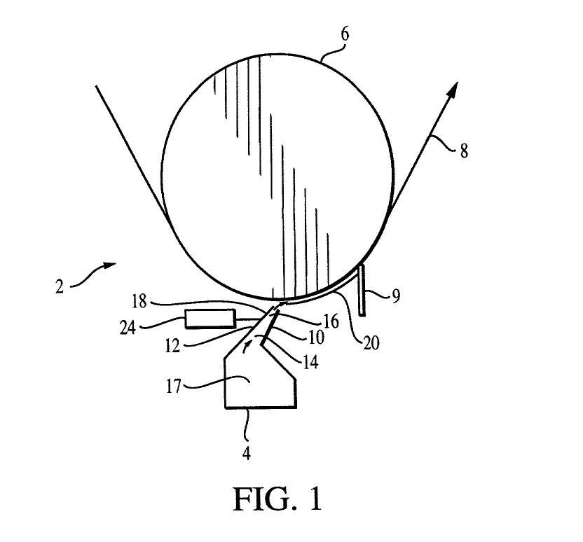

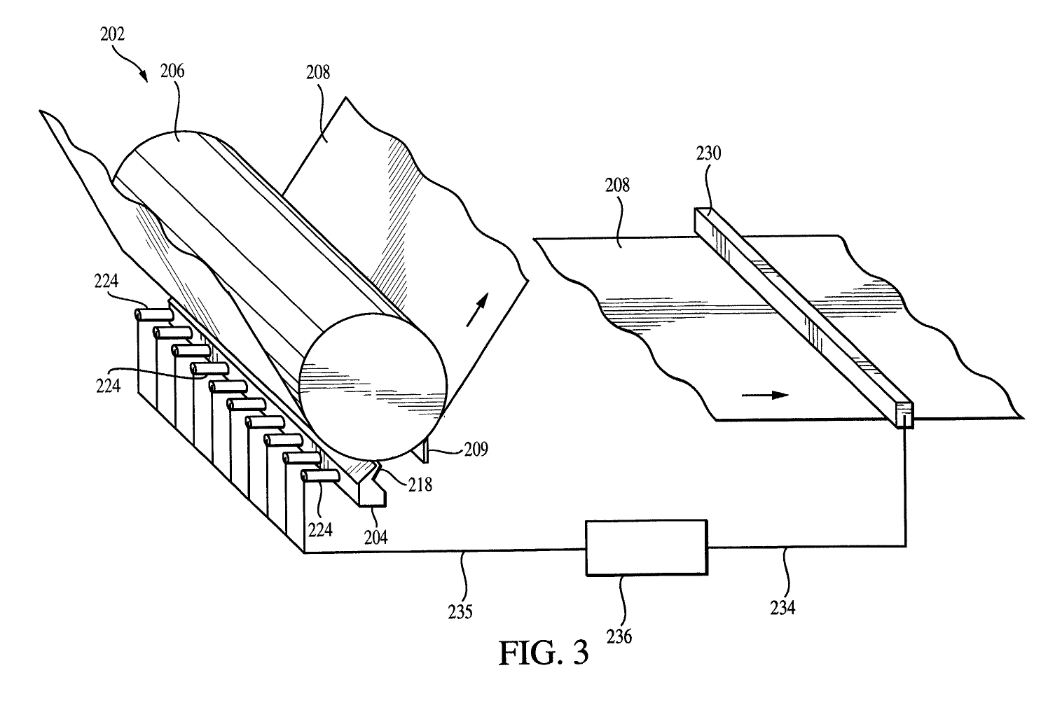

Turning now to the drawings by way of illustrating the best known modes for practicing the present invention, FIG. 1 is a schematic elevational view of a fountain coater station, indicated generally at 2 comprising a backing roll 6 for supporting a moving paper web 8, an applicator 4, and a doctor 9. Those knowledgeable in the art will understand that the coater station 2 may be a component of a paper machine (i.e., an on-machine coater) or may be a component of an off-machine coater. The coater station 2 extends in a cross-machine direction substantially coextensive with the width of the web 8, for example in FIG. 3.

The applicator 4 comprises a nozzle 18 having a front wall 10 and back wall 12. The walls define a metering slot 14 therebetween. The slot 14 has a minimum gap width 16 that is the closest separation of the front and back walls 14 and 16. A chamber 17 communicates with the slot 14. In operation a coating composition is delivered under pressure from the chamber 17 through the nozzle 18, and applied onto moving paper web 8. The nozzle 18 functions to meter the flow of coating material and impinge a uniform ribbon or sheet of coating onto the web, forming an excess coating layer 20 on the moving web. The coating layer is doctored to a desired coat weight by doctor 9.

Those skilled in the art will understand that the illustration of FIG. 1 is a general schematic only that is not drawn to scale, and that a coating station and an applicator in practice may comprise additional components. By way of example, the nozzle 18 may further comprise a curved lip, as is explained in U.S. Pat. No. 5,436,030 to Damrau (“the Damrau '030 patent”), herein incorporated by reference. Additional information regarding the construction and operation of coating stations and applicators appears in the Damrau '030 patent.

In operation, coating composition flow disruptions in one or more portions of the applicator 4 may occur. For example, particulate material may occasionally become lodged in the nozzle 18, causing disruptions in the flow of coating composition. Lodged particulate material may comprise fiber bundles, clumps of dried coating composition, foreign materials, and the like. Disruptions in the flow and application of coating material onto the web 8 cause streaks and other defects in the coating layer.

It has been discovered that coating flow disruptions in the applicator nozzle 18 are substantially avoided or cleared by vibrating at least a portion of the nozzle 18 with vibrations of a frequency, intensity, and magnitude sufficient to free the lodged matter from the nozzle 18. It will be appreciated that as used herein, the term “intensity” when used in relation to a vibration is intended to broadly refer to energy associated with a vibration, which is proportional to the acceleration of the plate. Intensity may thus be measured in terms of acceleration of a vibrating member, with a useful unit of measurement being the gravitational pull on earth (“G”) of 9.8 M/s². The term “magnitude” as used herein in reference to vibration is intended to broadly refer to a measure of distance a vibrating member travels during vibration, with units of measure of length useful for reference.

An apparatus embodiment of the present invention comprises one or more vibrators 24 attached to the applicator 4. In preferred embodiments of the invention magnetorestrictive vibrators 24 are used, however, pneumatic, mechanical, and the like mechanisms may prove suitable alternatives. Magnetorestrictive vibrators are preferred as they have been discovered to provide relatively high frequency, high intensity vibrations while requiring only limited input power.

Generally, magnetotorestrictive materials are characterized in that a strain may be caused in them through application of a magnetic field. This characterization may be manipulated to cause vibrations of a desired frequency through cyclical application of a magnetic current. Commercial vibrator apparatuses are available offering such capabilities, with an example being magnetorestrictive actuators available from Etrema Corp., Ames, Iowa. Additional details regarding technology and operation of magnetorestrictive devices are available in the literature, for example, “Magnetorestrictive Materials and Ultrasonics,” by T. Toby Hansen, Chemtech, American Chemical Society (August 1996).

Preferably, the vibrator 24 is attached to the nozzle 18 or other portion of the applicator where clogging is likely to occur. The vibrator 24 may be attached to the exterior of the applicator 4, or may be attached to an internal portion of the applicator 4. The vibrators may be attached to the applicator 4 in any manner, such as by bolting the vibrator to the wall 10 or 12.

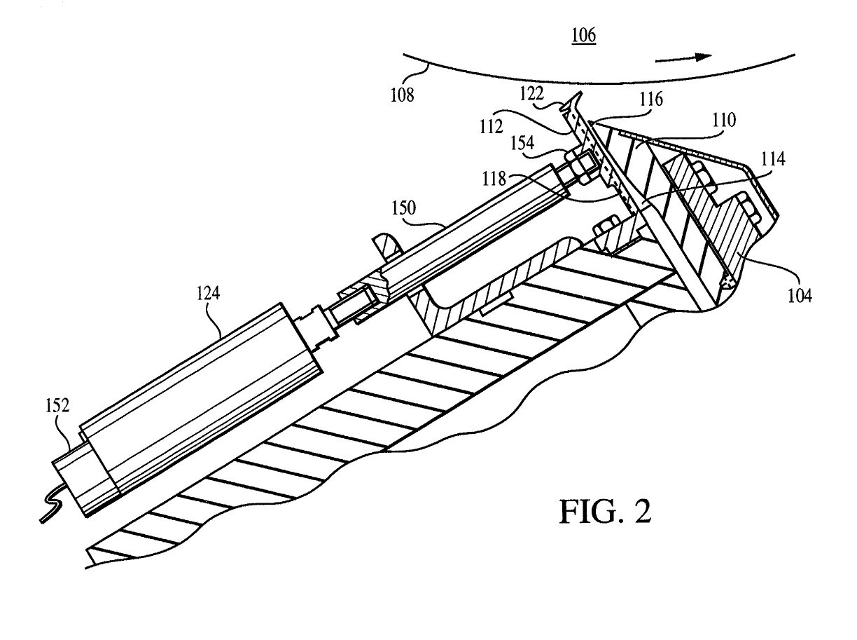

FIG. 2 illustrates an embodiment for retrofitting vibrators 124 to a pre-existing applicator 104. Components of the embodiment shown in FIG. 2 that are the same as shown in the first embodiment (FIG. 1) bear the same reference number, but in the 100 sequence. Applicator 104 comprises a nozzle 118 having a front wall 110 and back wall 112 defining a slot 114 therebetween. The slot tapers to a narrow portion 116, having a minimum gap width typically of about 0.8 to 1.0 mm. Preferably, the nozzle includes a curved lip 122. As is known in the art, many coating applicators are provided with a multiplicity of spaced adjustment screws for adjusting and maintaining a uniform width of the slot 114. In accordance with this embodiment of the invention, several of the adjustment screws are replaced with vibrator assemblies. More specifically, the nozzle 118 has a plurality of tapped adjustment screw mounts 154 spaced across the nozzle in the cross-machine direction. One or more vibrators 124 are attached to the lip 122 at selected locations. A connecting rod 150 mechanically connects each vibrator 124 to the nozzle through threaded connection at a tapped screw mount 154. Desirably, a weight 152 is attached to the vibrator 124 to add inertia mass to the vibrator assembly to improve the transmission of vibrations to the nozzle 118. As will be apparent from this disclosure, those skilled in the art may construct alternative mounts and other devices for attaching vibrators to the applicator within the scope of the present invention.

As illustrated for example in the perspective view of FIG. 3, in the preferred apparatus embodiment of the invention, a plurality of vibrators are connected to the applicator nozzle, spaced apart in the cross-machine direction. Preferably, the vibrators are substantially equidistantly spaced from one another. The spacing of the vibrators, in order to achieve satisfactory vibration, has been discovered to depend on the geometry of the applicator and nozzle, including the location of supports or anchor points along the applicator. For point of reference, however, a spacing of about 4 to 8 inches has been discovered to be useful for a particular applicator. Further, it may prove useful to replace adjustment screws with vibrators as generally illustrated in FIG. 3 in a pattern when retrofitting an existing coater. By way of example, it may prove useful to replace every other, or every third adjustment screw with a vibrator.

In the preferred embodiments of the invention the vibrators generate vibrations at a frequency substantially equal to a natural frequency of at least the portion of the nozzle to which it is connected. A natural frequency generally refers to the frequency at which a material achieves a peak intensity, and that there may be a plurality of natural frequency peaks over a given frequency range for a given material. It has been discovered that for practice of the present invention, a natural frequency of below about 20 kHz is desirable. Accordingly, as used herein the term “natural frequency” is intended to broadly refer to a vibration frequency below 20 kHz at which a peak intensity occurs.

Graph 1 illustrates an example frequency scan of an applicator nozzle:

[image]

The data of Graph 1 indicates that the subject nozzle has a natural frequency peak at about 1.8 kHz, and also has several smaller intensity peaks or natural frequencies for the example nozzle.

The present invention may further comprise a method for determining the natural frequency of a coater wall. There are a number of ways to make this determination. By way of example, experiments may be conducted using instruments to measure wall acceleration in response to various vibration frequencies. In particular, one or more vibrators and accelometers may be attached to a coater wall, with the accelometers used to record acceleration while vibration frequencies are varied. These experiments provide frequency vs. acceleration data in the general form illustrated by Graph 1.

The natural frequency of a given nozzle will depend on the material of construction, and the geometry of the nozzle, including wall thickness, width and length, the placement and nature of connections and supports. Further, it will be appreciated that a natural frequency may vary somewhat from place to place along the nozzle. It has been discovered, however, that treating a natural frequency as constant for the entire cross-machine extent of the nozzle is an acceptable practice in accordance with the several embodiments of the present invention. By way of particular example, it has been discovered that for a particular coater used for coating paper, the lip wall natural frequency is about 1.8 kHz. Although the walls of other coaters may have natural frequencies different from this value, it is predicted that natural frequencies for coaters in the paper coating arts may be found to be in the general range of about 0.5 to about 20 kHz.

Using vibrations at the natural frequency of the coater wall is advantageous for several reasons. Use of the natural frequency allows for high intensity vibrations to be generated with lower input power. Reference to Graph 1 will be helpful in illustrating this point. Vibrating the wall at a frequency of 1.8 kHz will result in an intensity of about 12 G, while vibrating the wall at a substantially higher frequency of 8-10 kHz will result in an intensity of only about 6 G at the most. Further, if several peak intensities are present, operating at a low frequency peak is preferred. This provides an advantage in generally reduced fatigue and increased service life of the machinery.

It will be appreciated that the present invention is not limited to vibration at a natural frequency. Indeed, one may generate vibrations at virtually any frequency found to be practical for a particular application. Preferably, however, vibration frequency will be less than about 20 kHz. Frequencies greater than 20 kHz are generally referred to as ultrasonic. Ultrasonic vibrations are deemed to be less advantageous than lower frequency vibrations for practice with the present invention. Further, these frequencies have relatively high input energy requirements to generate a given vibration intensity, and also may introduce greater fatigue in the nozzle structure.

It is desirable that the vibrations of the present invention generate relatively high intensity. Preferably, vibration intensity will be at least about 3 G. It has been found that this level of intensity is usually successful in removing clogs and other nozzle flow disruptions. Somewhat lower intensity levels (e.g., 1-2 G) are partly successful. Intensity levels greater than 4 G are most preferred as these have been found to have a very high success rate.

In addition to frequency and intensity, it has been discovered that the magnitude of the vibrations should be minimized. Generally, large vibration magnitudes may lead to metal fatigue. In addition, high vibration magnitudes may also “pinch” the applicator slot and cause flow disruptions, and undesirable coating layer thickness variations. It is believed that a magnitude of vibration that is less than about 10% of the minimum gap width will avoid these undesirable results. More preferably, the vibration magnitude should be kept below about 5% of the minimum gap width. It is also believed that magnitudes below about 3% of the minimum gap width will be useful. It is also desirable that some minimum magnitude is achieved, with a useful lower bound believed to be about 1% of the minimum gap width. By way of particular example, the minimum gap width of the metering slot for many paper coaters will be on the order of about 0.8-1 mm. It has been discovered in embodiments of the present invention, that good results were achieved with a vibration magnitude of about 24 micron for a minimum nozzle slot of 0.8-1.0 mm (i.e., a ratio of about 3% to about 5%).

When considering vibration frequency, intensity, and magnitude in combination, embodiments of the invention are believed to offer advantageous results when frequency is less than about 20 kHz, intensity is at least about 3 G, and magnitude is maintained at a ratio of less than about 10% of the minimum nozzle slot gap width. Vibrations having these qualities are useful for clearing particulate or other matter that may otherwise attach to the surface of the nozzle. The vibrations are believed to separate the nozzle wall from the clog, which is thereby freed and drawn away by the flow of coating fluid through the nozzle. It is also believed that the vibration frequency, intensity, and magnitude ranges of invention embodiments do not undesirably effect the coating composition. While the above-discussed limits on frequency, intensity, and magnitude are believed to be useful for practice of the preferred embodiments of the invention, it will be understood that practice of the present invention is not necessarily limited to these parameters. That is, other embodiments may be useful using vibrations with one or more of intensity, frequency, and/or magnitude values that fall outside of these limits.

Embodiments of the present invention may comprise continuous operation of the vibrators 24. This may be advantageous for preventing coating defects from occurring. This may also entail, however, relatively high-energy costs and unnecessary fatigue on the coater equipment. As an alternative to continuous operation, then, the present invention further contemplates additional control schemes for selective or otherwise non-continuous vibrator operation. These invention embodiments may be desired, for instance, to achieve energy, equipment wear, and other savings.

Additional vibrator control schemes for practice with embodiments of the invention comprise manual operation whereby the vibrators are manually turned on and off to resolve disruptions, and intermittent operation whereby the vibrators are cyclically turned on for a first period of time and off for a second period of time. When a plurality of vibrators are present and attached along the cross-machine dimension of an applicator, additional control schemes may comprise sequential operation of the vibrators in a reoccurring pattern. By way of example, a controller such as a wave generator may be used to generate a reoccurring sin wave or a square wave pattern along the cross-machine width of the applicator by sequentially operating the vibrators.

As an additional embodiment, a single vibrator, movable along the cross-machine width of the applicator, could be used. By way of example, a vibrator could be movably held on a track on the nozzle, the track running in the cross-machine direction. Through movement of the vibrator, different portions of the applicator wall could be vibrated as desired.

Still other control schemes for operation of the vibrators comprise a feedback type of control, such as that shown in FIG. 3. A system embodiment of the invention may comprise an electronic web inspection system 230 downstream of the coater station 202. Preferably, the inspection system 230 is placed downstream of the doctor 209. The inspection system 230 may comprise a plurality of individual sensors mounted, for instance, above the moving web on a support bar or the like. The sensors may comprise any suitable means for inspecting the web, with examples including but not limited to, visual inspection means such as electric eyes, infrared detection devices, or other forms of radiation.

An example of commercially available web inspection systems believed to be useful for practice of an invention embodiment comprises the ULMA Nti Web Inspection System available from ABB Instruments, Ltd., St. Neots, Cambs, England. Inspection means such as the ULMA System utilize optical sensors like charged coupled device (“CCD”) cameras to detect and identify defects in the paper web such as holes and coating streaks. A light source illuminates the web and the CCD cameras detect variation in intensity. Image processing computers then analyze the variations. The system is capable of providing information regarding the exact type and location of the defect.

The inspection system 230 inspects the web downstream of the coater station 204 to detect coating defects or other irregularities. By way of example, the inspection system 230 may be used to detect streaking, surface irregularities, or other indications that the flow of coating fluid through the applicator 204 is being clogged or otherwise disrupted. The inspection system may comprise a single, reciprocating sensor. Alternatively the inspection system may comprise a plurality of sensors spaced along the width of the web 208 such that a given sensor corresponds to a particular vibrator or group of vibrators. Each of the sensors may then be used to monitor a particular portion of the web along its cross-machine width. Each of the particular portions of the web corresponds to one or more of the particular vibrators. When a defect is detected in a particular cross-machine location of the web, the electric inspection means 230 may communicate a signal instructing that one or more of the particular vibrators 224 be operated. As shown in FIG. 3, a system embodiment of the invention may further comprise a controller 236 and communications lines 234, 235 for communicating with and controlling the web inspection system 230 and/or the vibrators 224.

In a feedback based control scheme, an example of which is disclosed in FIG. 3, operation of the vibrators 224 may continue for a predetermined amount of time. For example, time periods of about 5 seconds have been found to be useful. Further, it is believed that of time periods of no more than 20 or 30 seconds should be sufficient for achieving good results with practice of the invention. Other control schemes modifications may be used, for example, a feedback control scheme could include programming the web inspect system to communicate a second signal for terminating vibration upon concluding that a coating defect has been cleared or otherwise resolved.

The controller 36 may comprise any of a number of processor-based tools for control and communication with the web inspection system 230 and the vibrators 224. Examples include, but are not limited to, computers such as a personal computer, a laptop, a handheld computer, or a mainframe or server computer communicating with over a network, as well as dedicated processor based devices, program instructions running on a computer device, circuitry such as a printed circuit card or chipset, and the like. Further, it will be appreciated that the controller 236 is not limited to being a “stand alone” device as illustrated, but may for instance be contained, physically or functionally, within one or more of the web inspection systems 230, coater controller (not illustrated), or the like. Additionally, a single controller 236 may be used to control vibrator sets and web inspection systems on a two or more coater stations. The controller preferably communicates with the inspection system 230 and the vibrators 224 via the communications lines 234, 235 which may comprise a wireless connection such as an RF connection or the like, a LAN connection such as an ethernet, a WAN connection, a POTS connection, or any other suitable communication line.

It will be appreciated that variations are possible within the scope of the invention using a web inspection system as illustrated by FIG. 3. For example, a single electric eye may be used that has a field of vision spanning the entire width of the web and that could provide a reference for width location of coating defects. Alternatively, a single sensor could be used that was operated to relatively quickly scan the width of the web through movement across the web on a track, through pivotal rotation, or the like. The controller could be used to control and monitor this movement so that when a defect was discovered a corresponding vibrator could be activated.

As an additional example, a control logic embodiment of the invention may comprise activating more than a single vibrator in response to detection of a defect. For example, three vibrators could be activated corresponding to a particular web region of interest as well as the two neighboring zones. Or, if the defect was detected near one edge of a zone, two vibrators could be turned on corresponding to the web region of interest and the region nearest the edge where the defect is located. Further, it should be understood that the inspection regions and the vibrator regions need not correspond on a 1:1 basis. For example, one vibrator region may cover two inspection regions, or vice-versa. Accordingly, as used herein the term “corresponding” when used in reference to relations between the web inspection and vibrators will be broadly interpreted to include any relationship whereby detection of a defect at a particular location on the web may “correspond” to a vibrator location.

Other control scheme embodiments may be provided to conserve energy and costs. For example, an additional variation on continuous operation of the vibrators may be timed operation wherein only a portion of the plurality of vibrators are operating at a given time. By way of example, the vibrators may be turned on sequentially along the cross-machine width of the applicator 204, with one to three of the vibrators activated at any given time. Timed, sequential operations schemes may be used to generate square waves or sin waves in the applicator nozzle.

It will also be appreciated that the invention is not limited to practice with a single set of vibration frequency, intensity, and magnitude values. For example, vibrations could be initiated as desired at a relatively low magnitude, frequency, and intensity and then gradually increased until a defect is resolved.

It will be appreciated that the present invention may be useful in the form of a computer program product. Accordingly, it will be understood that the present invention may take the form of a computer program product for controlling a nozzle vibration system, the program product comprising computer readable instructions stored in a computer readable medium that when executed cause the computer to carry out steps of a method embodiment of the invention. It will be appreciated that the computer readable medium for storing the instructions may comprise any of a number of suitable mediums, with examples including, but not limited to, optical, magnetic, circuitry, micro-circuitry, and the like. Further, the term “computer” as used herein is intended to be broadly interpreted to describe any processor-based apparatus capable of executing program instructions. It will additionally be appreciated that computer program product embodiments of the invention will be useful for causing a computer to carry out method steps as have been discussed herein and for controlling systems as have been discussed herein.

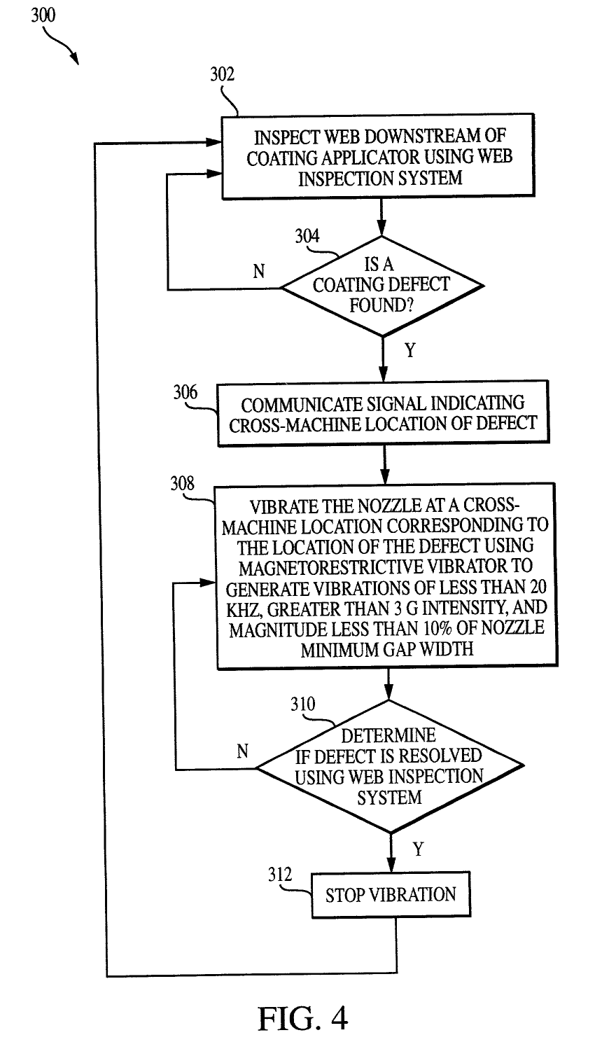

FIG. 4 is a flowchart illustrating the logic of an example computer program product embodiment 300 of the invention. The program product embodiment 300 causes a computer to inspect a web for coating defects using a web inspection system (block 302). If a defect is detected (block 304), the computer causes a signal to be communicated that indicates at least the cross-machine location of the coating defect (block 306).

After communication of this signal, the computer actuates at least one vibrator to vibrate a portion of the applicator nozzle that corresponds to the cross-machine location of the defect (block 308). The vibrator preferably generates vibrations at a frequency of less than 20 kHz, an intensity of at least 3 G, and a magnitude less than about 10% of the nozzle minimum width. In this program product embodiment 300, a feedback control scheme is used to terminate vibrations. That is, the computer causes the web inspection system to determine whether the coating defect has been resolved (block 310). If not, vibrations continue (block 308). If the defect has been resolved, vibrations are terminated (block 312). Other control schemes for controlling vibrator operation could of course be practiced with other computer program product embodiments of the invention. For example, upon detection of a defect, the program product may cause the vibrator to operate for a pre-determined amount of time, with an example period comprising about 5 sec.

It will also be appreciated that although discussion and description herein has been made to a particular paper coater apparatus, method, system and computer program embodiments such discussion and description is made by way of example only. Accordingly, it will be understood that the present invention as defined by the appended claims is not limited to any of the particular embodiments described above.

What is claimed is:

1. A method for clearing fluid flow disruptions in a coating applicator comprising,
vibrating at least a portion of the applicator at a frequency substantially equal to a natural frequency of said at least a portion of the applicator.

2. A method as defined by claim 1 wherein the step of vibrating comprises vibrating said at least a portion of the applicator using a magnetorestrictive vibrator with an intensity of at least 3 G, and wherein said frequency is less than about 20 kHz.

3. A method as defined by claim 1 wherein the applicator has a nozzle for conveying the fluid, the nozzle having a fluid metering slot with a minimum gap width, wherein the step of vibrating comprises vibrating the nozzle, the vibrations having a magnitude of less than about 10% of the minimum gap width of the slot.

4. A method as defined by claim 1 wherein the applicator is for coating a moving web, and wherein the method further comprises:
inspecting the moving web for coating defects downstream of the applicator; and
performing the step of vibrating at least a portion of the applicator in response to a defect.

5. A method for reducing coating flow disruptions in an applicator, the applicator having a nozzle with a metering slot having a minimum gap width, the method comprising:
vibrating at least a portion of the nozzle with vibrations having a frequency of less than about 20 kHz, an intensity of at least about 3 G, and a magnitude of less than about 10% of the slot minimum gap width.

6. A method as defined by claim 5 wherein said intensity is at least about 4 G, and said frequency is less than about 10 kHz, and said magnitude is between about 1% and about 5% of the slot minimum gap width.

7. A method as defined by claim 5 wherein said frequency is less than about 5 kHz, and wherein said magnitude is between about 1% and about 3% of the slot minimum gap width.

8. A method as defined by claim 5 wherein the step of vibrating comprises using at least one magnetorestrictive vibrator connected to the nozzle.

9. A method as defined by claim 5 wherein the applicator extends in a cross-machine direction, and wherein the step of vibrating at least a portion of the nozzle comprises using a plurality of magnetorestrictive vibrators each connected to the nozzle and spaced apart one from the other in the cross-machine direction.

10. A method as defined by claim 9 wherein the method further comprises operating said vibrators in a reoccurring sequential pattern along the cross-machine width of the nozzle wherein only a portion of said plurality of vibrators are operating at any given time.

11. A method as defined by claim 5 wherein the method further comprises controlling the step of vibrating according to a control scheme, said control scheme selected from the group of control schemes consisting of substantially continuous operation, intermittent operation, and manual operation.

12. A method as defined by claim 5 for applying coating to a moving paper web, wherein the applicator extends in a cross-machine direction that is substantially coextensive with the web width, and wherein the method comprises the steps of:
inspecting the web downstream from the applicator for coating defects;
locating defects in the web;
communicating a signal, the signal indicating the cross-machine location of the defect; and
wherein the step of vibrating at least a portion of the nozzle is in response to the signal and comprises vibrating a portion of the nozzle that corresponds to the cross-machine location of the defect.

13. A method as defined by claim 12 wherein the step of vibrating is performed for a pre-determined length of time less than about 20 seconds.

14. A method as defined by claim 12 wherein the steps of inspecting the web and locating defects are performed using a web inspection system.

15. A method as defined by claim 5 wherein the nozzle has a metering slot, and wherein the disruption is caused by a particle on a nozzle surface in the metering slot, and wherein the method step of vibrating comprises vibrating the nozzle adjacent the metering slot to separate the nozzle surface from the particle.

16. A method for reducing coating flow disruptions through an applicator for applying coating to a moving paper web, the applicator having a nozzle with a metering slot therein, the slot having a minimum gap width, the applicator extending in a cross-machine direction, the method comprising the steps of:
inspecting the web downstream of the applicator for coating defects;
locating a coating defect in the cross-machine direction of the web, and
vibrating the nozzle in response to a coating defect at the cross-machine location of the defect with at least one magnetorestrictive vibrator, the vibrations having a frequency of less than about 10 kHz, an intensity of at least about 4 G, and a magnitude less than about 10% of the minimum gap width.

17. A method as defined by claim 16 wherein said frequency is substantially equal to the natural frequency of the at least a portion of the nozzle.

18. An apparatus for clearing particulate matter from a coating applicator, the applicator having a nozzle with a coating metering slot therein, the slot having a minimum gap width, comprising
at least one vibrator connected to the nozzle for vibrating at least a portion of the nozzle with vibrations having a frequency of less than about 20 kHz, an intensity of at least about 3 G, and a magnitude less than about 10% of the minimum gap width of the nozzle slot.

19. An apparatus as in claim 18 wherein said vibration frequency is less than about 10 kHz and said intensity is at least about 4 G.

20. An apparatus as in claim 18 wherein said vibration frequency is less than about 10 kHz and said magnitude is between about 1% and 3% of said minimum gap width.

21. An apparatus as in claim 18 wherein said applicator extends in a cross-machine direction, and wherein said at least one vibrator comprises a plurality of magnetorestrictive vibrators connected to said nozzle, spaced apart from one another along the cross-machine direction of said nozzle.

22. An apparatus as in claim 18 wherein said frequency comprises a natural frequency of said at least a portion of the nozzle.

23. A system for clearing flow disruptions from a coater, the coater for applying a coating composition to a moving paper web, the system comprising:
a coating applicator having a nozzle with a metering slot therein, said nozzle for applying coating to the paper web;
web inspection means downstream of said applicator for detecting a coating defect on the moving web; and
at least one vibrator connected to said nozzle for vibrating at least a portion of said nozzle with vibrations in response to detection of the coating defect by said web inspection means, said vibrations having a frequency of less than about 20 kHz, and an intensity of at least about 3 G.

24. A system as defined by claim 23 wherein said web inspection means inspects a plurality of web portions in the cross-machine direction of the web, and wherein said web inspection means communicates a signal on detection of the defect, said signal comprising a cross-machine location of said defect.

25. A system as defined by claim 23 wherein the web has a cross-machine width, and wherein:
said nozzle has a cross-machine dimension substantially coextensive with the web width;
said web inspection means comprising a plurality of sensors spaced apart along the cross-machine width of the web, each of said sensors for detecting a defect in a portion of the web; and
said at least one vibrator comprises a plurality of vibrators connected to said nozzle and spaced apart along the cross-machine dimension of said nozzle, whereby one or more selected ones of said vibrators are actuated in response to a defect detected by one of said sensors.

26. A system as in claim 23 further comprising a controller in communication with said web inspection means for controlling said at least one vibrator.

27. A system as in claim 23 wherein said web inspection means comprises at least one electric eye, and wherein said at least one vibrator comprises at least one magnetorestrictive vibrator.

28. A system as in claim 23 wherein said nozzle slot has a minimum gap width, and wherein said vibrations have a frequency of less than about 10 kHz, an intensity of at least about 4 G, and a magnitude of less than about 10% of said minimum gap width.

29. A system as in claim 23 wherein said slot has a minimum gap width, and wherein said vibrations have a frequency substantially equal to a natural frequency of said nozzle, an intensity of at least about 4 G, and a magnitude between about 1% and 5% of said minimum gap width.

30. A computer program product for controlling a coating applicator, the applicator having a nozzle with a slot formed therein, the slot having a minimum gap width, the program product comprising computer executable instructions stored on a computer readable medium that when executed by a computer cause the computer to:
use at least one vibrator to vibrate at least a portion of the nozzle with vibrations having a frequency of less than about 20 kHz, an intensity of at least 3 G, and a magnitude that is less than about 10% of the minimum gap width.

31. A computer program product as in claim 30 wherein said frequency is substantially equal to a natural frequency of the at least a portion of the nozzle.

32. A computer program product as in claim 30 wherein the applicator for applying coating a moving web, and wherein the program instructions when executed further cause the computer to:
inspects the moving web for a coating defects using a web inspection system located downstream of the applicator; and
perform the step of vibrating the at least a portion of the nozzle in response to detection of a defect.

33. A computer program product as defined by claim 32 wherein the moving web has a cross-machine width and the applicator nozzle and web inspection system extend in a cross-machine direction substantially coextensive with the web, wherein the program instructions further cause the computer to locate defects in the cross-machine direction using the web inspection system, to communicate a signal comprising the location of defects, and to vibrate a portion of the nozzle at a location in the cross-machine direction that corresponds to the defects.

34. A computer program product as defined by claim 33 wherein said at least one vibrator comprises a plurality of vibrators connected to the nozzle, spaced apart one from another in the cross-machine direction, and wherein the program instructions when executed cause at least one of said vibrators at a location approximately corresponding to the cross-machine location of a defect to vibrate.
